(19) United States
(12) Patent Application Publication
(10) Pub. No.: US 2011/0148336 A1
(43) Pub. Date: Jun. 23, 2011

(54) MOTOR CONTROL DEVICE AND METHOD FOR CONTROLLING BRUSHLESS MOTOR

(75) Inventor: Yoshitaka HAYASHI, Obu-city (JP)

(73) Assignee: DENSO CORPORATION, Kariya-city (JP)

(21) Appl. No.: 12/976,237

(22) Filed: Dec. 22, 2010

(30) Foreign Application Priority Data
Dec. 22, 2009 (JP) 2009-290725

(51) Int. Cl. H02P 6/16

(52) U.S. Cl. 318/400.04

(57) ABSTRACT

A motor control device detects electric currents on two perpendicular axes and calculates voltage command values on the two perpendicular axes according to deviations between the detected electric currents and target current values respectively, thereby to perform feedback control of a brushless motor equipped with a rotation angle sensor. On the premise that a γ axis, which represents a phase component, and a δ axis, which represents a torque component, become control axes due to an assembly error of the rotation angle sensor, a correction value calculation unit of the motor control device sets an electric current on the γ axis to 0 to establish a no-load steady rotation state and calculates the assembly error from a voltage equation on γ-δ axes.

### CROSS REFERENCE TO RELATED APPLICATIONS

This application is based on and incorporates herein by reference Japanese Patent Application No. 2009-290725 filed on Dec. 22, 2009.

### FIELD OF THE INVENTION

The present invention relates to a motor control device. The present invention relates to a method for controlling brushless motor.

### BACKGROUND OF THE INVENTION

In recent years, an electric power steering system (EPS system) is attracting attention as a system for assisting operation of a steering wheel of a vehicle. Such an electric power steering system (EPS system) is configured to cause a torque electrically. In many cases, a brushless motor is used as an output power source of an EPS system. The rotation position of a rotor of a brushless motor needs to be detected for controlling the brushless motor. Therefore, a rotation angle sensor, such as a hall element or a resolver, is provided to a brushless motor. When the mount position of a rotation angle sensor is inaccurate, variation arises between an actual electric angle and an ideal electric angle. When a motor is controlled in such a state, motor torque may decrease by the variation in the electric angle.

As follows, the decrease in the motor torque will be described with reference to FIG. 6. In the present example, the brushless motor has three-phase windings supplied with electric current, which are different in phase. In order to simplify control of the motor, three-phase electric currents are converted into an electric current on a q axis, which represents a torque component, and an electric current on a d axis, which represents a phase component, and feedback calculation is performed. Motor torque is proportional to an electric current on the q-axis. Therefore, an ideal motor torque Tm* is expressed by the following equation (1) with an ideal electric current i* on the q-axis and a magnetic flux Φ.

Tm*=Φ·i* (1)

An actual electric current i is equal to the ideal electric current i*. In consideration of an electric angle error Δθ, as shown in FIG. 6, an actual electric current iq on the q axis is expressed by the following equation (2).

iq=i·cos Δθ (2)

An actual motor torque Tm is expressed by the following equation (3).

Tm=Φ·iq (3)

Thus, the following equation (4) is obtained from the equations (1) to (3).

Tm=Tm*·cos Δθ (4)

Thus, as being obvious from the equation (4), the actual motor torque Tm becomes smaller than the ideal motor torque Tm* by the amount of cos Δθ due to variation in the electric angle.

Further, as shown in FIG. 6, the variation in the electric angle causes an electric current id on the d axis. In the example of FIG. 6, when the motor rotates clockwise (CW), the electric current id on the d axis acts in a direction to accelerate (advance) rotation of the motor. Alternatively, when the motor rotates counterclockwise, the electric current id on the d axis acts in a direction to decelerate (retard) rotation of the motor. As a result, difference arises between the clockwise rotation of the motor and the counterclockwise rotation of the motor.

In consideration of such a problem, for example, publication of Japanese patent 4000896 discloses a conventional art to correct variation in the electric angle, i.e., assembly error. According to the conventional art, a device supplies lock electric currents into a motor to correct assembly error.

FIG. 7 is a graph showing a relation between rotation angle and electric currents supplied to the three-phase windings of the U phase, the V phase, and the W phase. The lock electric currents are electric currents in the U phase, the V phase, and the W phase, corresponding to a certain rotation angle. More specifically, the lock electric currents are, for example, electric currents in the U phase, the V phase, and the W phase, corresponding to an angle A. When the motor is supplied with lock electric currents, a rotor of the motor is maintained at a certain position. That is, assembly error can be detected theoretically by supplying lock electric currents into the motor to lock the motor at an ideal angle. However, components of the motor control system, such as windings and an inverter circuit, may have variations in reality. Therefore, the motor may not be locked necessarily at the ideal angle. In consideration of such a problem, as shown in FIG. 7, electric currents corresponding to the angle B, the angle C, the angle D, the angle E, and the angle F may be supplied as the lock electric currents, in addition to the electric currents at the angle A, in order to average variations.

It is noted that, in a case of a three-phase motor having, for example, fourteen poles and twelve slots, a rotation angle sensor outputs electric angles for seven cycles while the motor makes one revolution, in general. Therefore, the motor needs to be supplied with electric currents for seven cycles in order to take into consideration variations in the rotation angle sensor. Therefore, in order to detect an assembly error in the three-phase motor having fourteen poles and twelve slots, the motor needs to be supplied with six patterns of electric currents corresponding to the angle B, the angle C, the angle D, the angle E, and the angle F, for seven cycles. That is the motor needs to be supplied with forty-two patterns of electric currents in total. Thus, when supply of lock electric currents to a motor is employed as a method for detecting an assembly error in consideration of variations in components such as windings, an inverter circuit, and a rotation angle sensor, a long detection time period is needed for the detection, in reality.

### SUMMARY OF THE INVENTION

In view of the foregoing and other problems, it is an object of the present invention to produce a motor control device configured to detect an assembly error of a rotation angle sensor quickly. It is another object of the present invention to produce a method for controlling brushless motor equipped with the rotation angle sensor.

According to one aspect of the present invention, a motor control device configured to detect electric currents on two perpendicular axes and calculate voltage command values on the two perpendicular axes according to deviations between the detected electric currents and target current values respectively thereby to perform feedback control of a brushless motor equipped with a rotation angle sensor, the motor control device comprises a correction value calculation unit configured to, on the premise that ideal control axes are shifted to γ-δ control axes, which include a γ axis representing a phase component and a δ axis representing a torque component, due to an assembly error of the rotation angle sensor, set an electric current on the γ axis to 0 to establish a no-load steady rotation state and calculate the assembly error as a correction value from a voltage equation on the γ-δ control axes.

According to another aspect of the present invention, a method for controlling a brushless motor equipped with a rotation angle sensor, the method comprises, on the premise that ideal control axes of the brushless motor are shifted to γ-δ control axes, which include a γ axis representing a phase component and a δ axis representing a torque component being perpendicular to each other, due to an assembly error of the rotation angle sensor, setting an electric current on the γ axis to 0 to establish a no-load steady rotation state and calculating the assembly error as a correction value from a voltage equation on the γ-δ control axes. The method further comprises obtaining an electric angle from a signal of the rotation angle sensor. The method further comprises correcting the obtained electric angle by using the calculated correction value in feedback control of the brushless motor. The method further comprises detecting electric currents on the control axes with reference to the corrected electric angle. The method further comprises calculating voltage command values on the control axes according to deviations between the detected electric currents and target current values respectively thereby to perform the feedback control of the brushless motor with reference to the corrected electric angle.

For example, the error angle may be calculated by substituting the voltage command values Vγ, Vδ on the γ axis and the δ axis into the subsequent equation (5).

$$Δθ \approx {tan}^{- 1} ( - \frac{V γ}{V δ} ) \qquad ( 5 )$$

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a motor control system according to one embodiment;

FIG. 2 is a flow chart showing a correction value calculation processing;

FIG. 3 is a flow chart showing an assembly offset angle processing;

FIG. 4 is a schematic view showing a relation between a variation in an electric angle and a control axis;

FIG. 5 is a flow chart showing an electric angle correction processing;

FIG. 6 is a schematic view showing an influence caused by a variation in the electric angle; and

FIG. 7 is a graph showing patterns of lock currents.

### DETAILED DESCRIPTION OF PREFERRED EMBODIMENTS

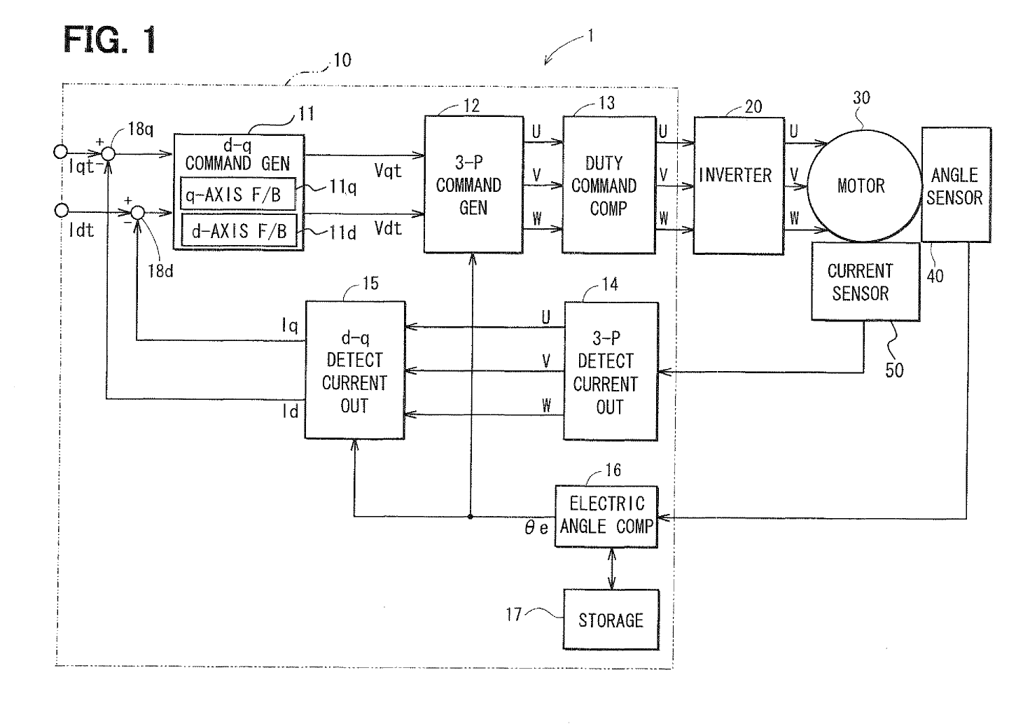

As follows, an embodiment of the present invention will be described with reference to drawings. A motor control device according to the present embodiment is equipped with a motor and provided in a vehicle to be configured as an EPS system. As shown in FIG. 1, a motor control system 1 includes a motor control device 10, an inverter 20, a motor 30, a rotation angle sensor 40, and a current sensor 50.

The motor control device 10 is configured as a microcomputer. FIG. 1 is a block diagram partially showing functions included in the microcomputer of the motor control device 10. The inverter 20 is mainly configured of switching elements corresponding to a U phase, a V phase, and a W phase. Each switching element includes a pair of an upper MOS and a lower MOS. The upper MOS and the lower MOS have a connection point therebetween, and the connection point is connected with a winding of the motor 30. The inverter 20 activates and deactivates the upper MOS and the lower MOS exclusively according to a signal from the motor control device 10 thereby to generate an electric current supplied to the motor 30.

The motor 30 is a brushless motor. Specifically, the motor 30 is, for example, a surface permanent magnet motor (SPM) being a 12-slot brushless motor including a rotor having fourteen N and S poles in total on the surface.

The rotation angle sensor 40 is configured to detect a rotation position of the motor 30. Specifically, the rotation angle sensor 40 is configured to detect a rotation position of the rotor of the motor 30. The rotation angle sensor 40 outputs a signal to the motor control device 10 to enable the motor control device 10 to identify the rotation position. The rotation angle sensor 40 may be a hall element or a resolver.

The current sensor 50 is configured to detect an electric current, which flows into each of a U-phase winding, a V-phase winding, and a W-phase winding of the motor 30, and output a signal to the motor control device 10 to enable the motor control device 10 to identify the detected electric current.

As follows, a structure of the motor control device 10 will be described in detail. The motor control device 10 includes a dq-axis command voltage generation unit 11, a three-phase command voltage generation unit 12, a duty command computation unit 13, a three-phase detection current output unit 14, a dq-axis detection current output unit 15, a motor electric angle computation unit 16, and a correction value storage unit 17.

The dq-axis command voltage generation unit 11 includes a q-axis feedback computation unit 11q and a d-axis feedback computation unit 11d. The q-axis feedback computation unit 11q generates a q-axis voltage command value Vqt. The d-axis feedback computation unit 11d generates a d-axis voltage command value Vdt.

The feedback computation units 11q, 11d input deviations in electric currents calculated by the computation units 18q, 18d, respectively. The computation unit 18q outputs a deviation between a q-axis target current Iqt and a detected q-axis electric current Iq. The computation unit 18d outputs a deviation between a d-axis target current Idt and a detected d-axis electric current Id.

The dq-axis command voltage generation unit 11 performs feedback control so that the deviation between the target current Iqt and the actual electric current Iq flowing into the motor 30 become small, and the deviation between the target current kit and the actual electric current Id flowing into the motor 30 become small.

The q-axis voltage command value Vqt and the d-axis voltage command value Vdt generated by the dq-axis command voltage generation unit 11 are outputted to the three-phase command voltage generation unit 12.

The three-phase command voltage generation unit 12 generates three-phase voltage command values corresponding to the U phase, V phase, and W phase, respectively, according to the q-axis voltage command value Vqt and the d-axis voltage command value Vdt and outputs the generated three-phase voltage command values to the duty command computation unit 13. That is, the three-phase command voltage generation unit 12 performs two-phase to three-phase conversion. Generation of the three-phase voltage command values also utilizes an electric angle θe, which will be described later.

The duty command computation unit 13 outputs duty signals to the inverter 20 according to the three-phase voltage command values outputted from the three-phase command voltage generation unit 12. In this way, the motor 30 is controlled according to the q-axis voltage command value Vqt and the d-axis voltage command value Vdt generated by the dq-axis command voltage generation unit 11.

The three-phase detection current output unit 14 outputs three-phase detection currents corresponding to the U phase, the V phase, and the W phase according to signals from the current sensor 50. The dq-axis detection current output unit 15 outputs the q-axis electric current Iq and the d-axis electric current Id according to the three-phase detection currents outputted from the three-phase detection current output unit 14. That is, the dq-axis detection current output unit 15 performs three-phase to two-phase conversion. The q-axis electric current Iq and the d-axis electric current Id are generated by utilizing the electric angle θe, which will be described later.

The computation unit 18q inputs the q-axis electric current Iq outputted from the dq-axis detection current output unit 15. The computation unit 18d inputs the d-axis electric current Id. In this way, the deviation with respect to the target current Iqt and the deviation with respect to the target currents Idt are calculated, as described above.

The motor electric angle computation unit 16 outputs the electric angle θe according to a signal from the rotation angle sensor 40. The three-phase command voltage generation unit 12 and the dq-axis detection current output unit 15 input the outputted electric angle θe.

In the motor control device 10, the motor electric angle computation unit 16 outputs the electric angle θe according to the signal from the rotation angle sensor 40, in this way. It is noted that variation occurs in the electric angle θe due to assembly error of the rotation angle sensor 40 and the like. Due to such a variation, the dq-axis control may not be performed desirably. As a result, motor torque may decrease, and deviation may arise in rotation when the motor rotates in different rotative directions.

In consideration of this, in the motor control device 10 according to the present embodiment, the motor electric angle computation unit 16 corrects the electric angle θe. A correction value of the electric angle θe is stored in the correction value storage unit 17.

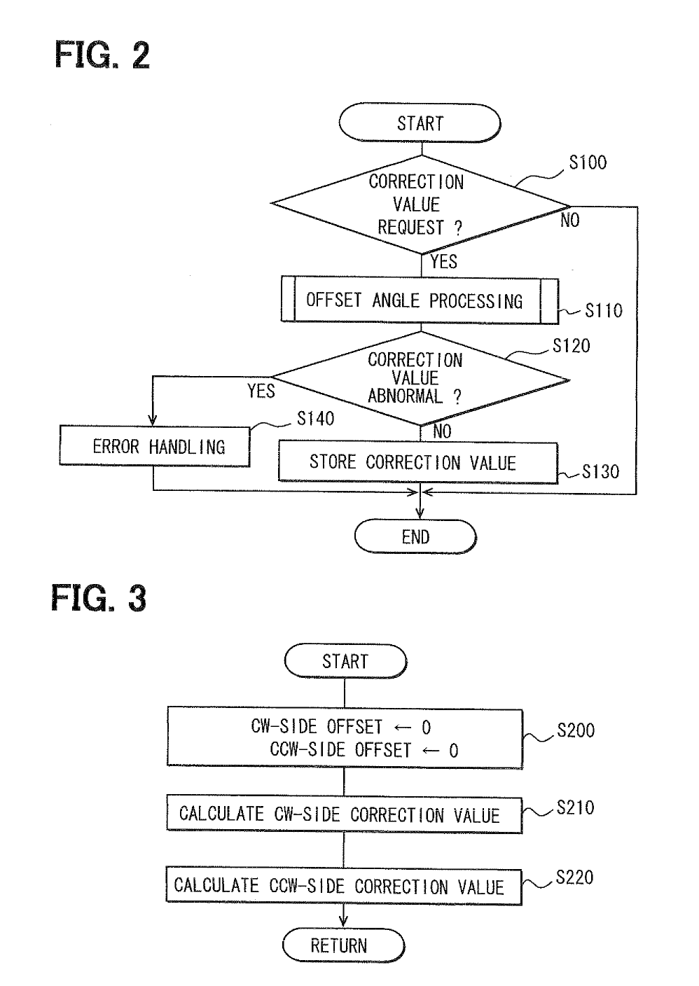

Subsequently, calculation of the correction value of the electric angle will be described in detail. FIG. 2 is a flow chart showing a correction value calculation processing. The present processing is executed in, for example, an inspection process before the device is assembled to a vehicle.

At step S100, it is determined whether calculation of the correction value is requested. The present processing is executed for determining a trigger of correction value calculation. For example, a request for the correction value calculation may be transmitted via a communication with an external object (device) or the like. Alternatively, a request for the correction value calculation may be made directly from an operation unit such as a DIP switch mounted on the motor control device 10. When it is determined that a request for the correction value calculation is made (S100: YES), the processing proceeds to step S110. Alternatively, when it is determined that a request for the correction value calculation is not made (S100: NO), the correction value calculation processing is terminated without execution of the subsequent processings.

At step S110, an assembly offset angle processing is executed. In the present assembly offset angle processing as shown in FIG. 3, at step S200, both a clockwise-side (CW-side) offset and a counterclockwise-side (CCW-side) offset are reset, i.e., set to 0. At step S210, the correction value on the side of clockwise is calculated. At step S220, the correction value on the side of counterclockwise is calculated. A thereafter, the assembly offset angle processing is terminated.

Referring to FIG. 2, at step S120, it is determined whether the correction value calculated at step S110 is abnormal. When it is determined that the correction value is normal (S120: NO), the correction value is stored in the correction value storage unit 17 at step S130. Thereafter, the correction value calculation processing is terminated. Alternatively, when it is determined that the correction value is abnormal (S120: YES), an error handling processing is executed at step S140 to exhibit that the correction value is abnormal. Thereafter, the correction value calculation processing is terminated.

Subsequently, calculation of the correction value at step S210 and step S220 in FIG. 3 will be described in detail. The calculation processings of the correction value at step S210 and step S220 are equivalent excluding the rotative direction.

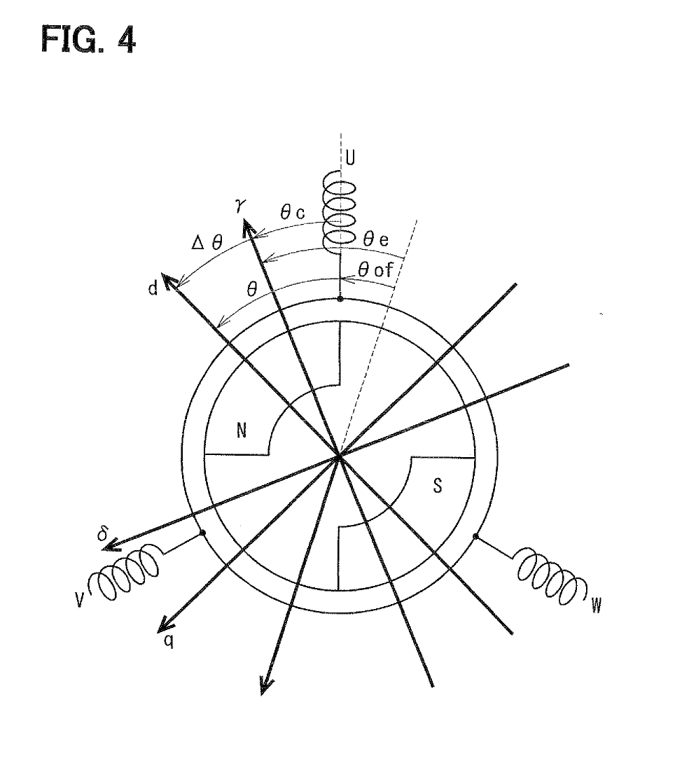

As shown in FIG. 4, an ideal electric angle θ, which is an ideal electric angle, is specified as a reference by an angle between the d-axis and the U-phase winding. When an actual electric angle θe, which is an actual electric angle, is equal to the ideal electric angle θ, control on the d-q axes is performed.

in reality, variation arises in the electric angle due to an assembly offset angle θof. The assembly offset angle θof is an assembly error caused when the rotation angle sensor 40 is mounted to the motor 30. Accordingly, when control is performed according to the actual electric angle θe, control on γ-δ axes is performed.

At this time, a control angle θc between the U-phase winding and the γ axis is expressed by the following equation (6) with the actual electric angle θe and the assembly offset angle θof.

θc=θe−ƒof (6)

The actual electric angle θe is equal to the ideal electric angle θ. Therefore, the error angle Δθ, which is a variation in the electric angle, is equal to the assembly offset angle θof. That is, the error angle Δθ is expressed by the following equation (7) with the assembly offset angle θof.

Δθ=θof (7)

Therefore, obtaining of the assembly offset angle θof suffices to calculate the error angle Δθ. A voltage equation on the γ-δ axes can be expressed by the subsequent equation (8).

$$[ \begin{matrix}V γ \\ V δ\end{matrix} ] = [ \begin{matrix}R + \dot{θ} m L γδ + pL γ & - \dot{θ} m L δ - pL γδ \\ \dot{θ} m L γ - pL γδ & R - \dot{θ} m L γ δ + pL δ\end{matrix} ] [ \begin{matrix}i γ \\ i δ\end{matrix} ] + e [ \begin{matrix}- sin Δθ \\ cos Δ θ\end{matrix} ] \qquad ( 8 )$$

Vγ: γ-axis voltage command value

Vδ: δ-axis voltage command value

iγ: γ-axis electric current

iδ: δ-axis electric current

Lγ: γ-axis inductance

Lδ: δ-axis inductance

Lγδ: γδ-axis mutual inductance

Lq: q-axis inductance

Ld: d-axis inductance

R: motor winding resistance+inverter resistance

θm: motor rotation angular speed

e: induced voltage constant

Further, relations expressed by the following equations (9) to (11) are formed.

$$\begin{matrix}L γ = \frac{1}{2} \{ ( Ld + Lq ) - ( Lq - Ld ) cos 2 Δ θ \} & ( 9 ) \\ L δ = \frac{1}{2} \{ ( Ld + Lq ) - ( Lq - Ld ) cos 2 Δθ \} & ( 10 ) \\ L γ δ = \frac{1}{2} ( Lq - Ld ) sin 2 Δ θ & ( 11 )\end{matrix}$$

Since the motor is the SPM, following equation (12) is formed.

Ld≈Lq (12)

Therefore, following equations (13) to (15) are formed.

Lγ≈Ld (13)

Lδ≈Lq (14)

Lγδ≈0 (15)

Therefore, the equation (8) is simplified to the following equation (16).

$$[ \begin{matrix}V γ \\ V δ\end{matrix} ] = [ \begin{matrix}R + pLd & - \dot{θ} m Lq \\ \dot{θ} m Ld & R + pLq\end{matrix} ] [ \begin{matrix}i γ \\ i δ\end{matrix} ] + e [ \begin{matrix}- sin Δθ \\ cos Δθ\end{matrix} ] \qquad ( 16 )$$

When the γ-axis electric current, which is the control axis of the d axis, is set to 0 to form a steady rotation state with no load, the following equation (17) is formed.

iγ≈0 (17)

Therefore, the above-described equation (16) is further simplified to the following equation (18).

$$[ \begin{matrix}V γ \\ V δ\end{matrix} ] = [ \begin{matrix}- \dot{θ} m Lqi δ - e sin Δ θ \\ ( R + pLq ) i δ + e cos Δ θ\end{matrix} ] \qquad ( 18 )$$

The following equations (19), (20) are obtained by expanding the equation (18).

e sin Δθ=−\dot{θ}mLqiδ−Vγ (19)

e cos Δθ=−(R+pLq)iδ+Vδ (20)

The following equation (21) expressing the error angle Δθ is obtained from the equations (19), (20).

$$\begin{matrix}Δθ = {tan}^{- 1} ( \frac{\dot{θ} m Lqi δ + V γ}{( R + pLq ) i δ - V δ} ) \\ = {tan}^{- 1} ( \frac{\frac{\dot{θ} m Lqi δ}{V δ} + \frac{V γ}{V δ}}{\frac{( R + pLq ) i δ}{V δ} - 1} )\end{matrix} \qquad ( 21 )$$

In consideration of steady rotation with no load and a motor characteristic, the following equations (22), (23) are formed.

$$\begin{matrix}\frac{\dot{θ} m Lqi δ}{V δ} \approx 0 & ( 22 ) \\ \frac{( R + pLq ) i δ}{V δ} \approx 0 & ( 23 )\end{matrix}$$

Therefore, the error angle Δθ is expressed by the following equation (24).

$$Δθ \approx {tan}^{- 1} ( - \frac{V γ}{V δ} ) \qquad ( 24 )$$

As described above, according to the present embodiment, the γ-axis electric current is set to 0 to form a steady rotation state with no load, and the error angle Δθ is obtained from the voltage equation on the γ-δ axes. In this case, the voltage equation is simplified by setting the γ-axis electric current to 0 to form the steady rotation state with no load and by utilizing the characteristic of the motor 30 being an SPM. The error angle Δθ, i.e., the assembly offset angle θof can be calculated by substituting the control voltage command values Vγ, Vδ into the equation (24). In the present embodiment, calculation of the correction value in this way is performed in both the clockwise rotation and the counterclockwise rotation.

Subsequently, determination of abnormality of the calculated correction value will be described. For example, determination of abnormality of the correction value executed at step S120 in FIG. 2 may be made in the following way.

(1) Utilize Assembly Error

A design error (tolerance) at the time of assembly is known beforehand. Therefore, it is highly possible that a correction value exceeding a range of such a design error is abnormal.

(2) Calculate Correction Value Utilizing Calculated Correction Value

When the correction value is calculated similarly by utilizing the calculated correction value, the correction value calculated second becomes approximately 0 when being a normal correction value. Similarly, it may be confirmed whether the γ-axis voltage command value Vγ becomes approximately 0 by utilizing the calculated correction value.

(3) Obtain Difference Between Correction Values in Clockwise Rotation and Counterclockwise Rotation

Theoretically, the correction value in the clockwise rotation and the correction value in the counterclockwise rotation do not have a difference therebetween in a single motor. In this regard, a fact is noted that the correction values in different rotative directions are not the same. Therefore, according to the present embodiment, the correction values in both the clockwise rotation and the counterclockwise rotation are calculated. Nevertheless, when the difference between the correction values becomes greater than a certain value, it is highly possible that the correction values are abnormal.

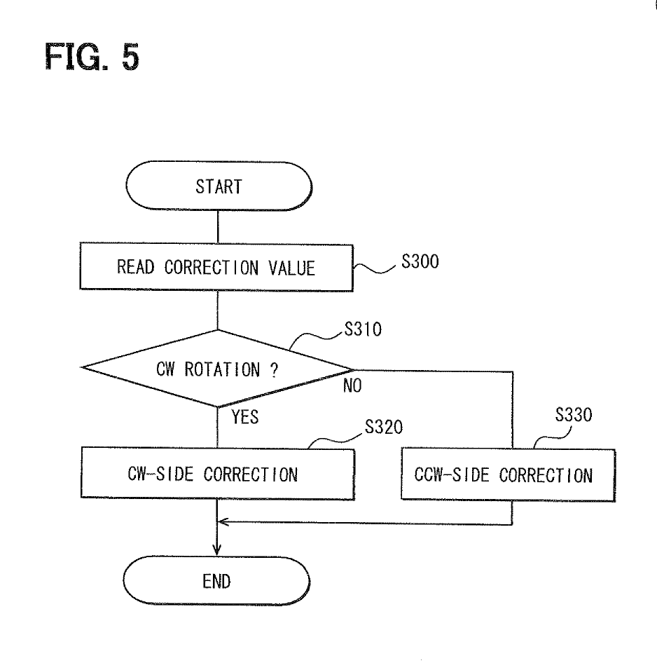

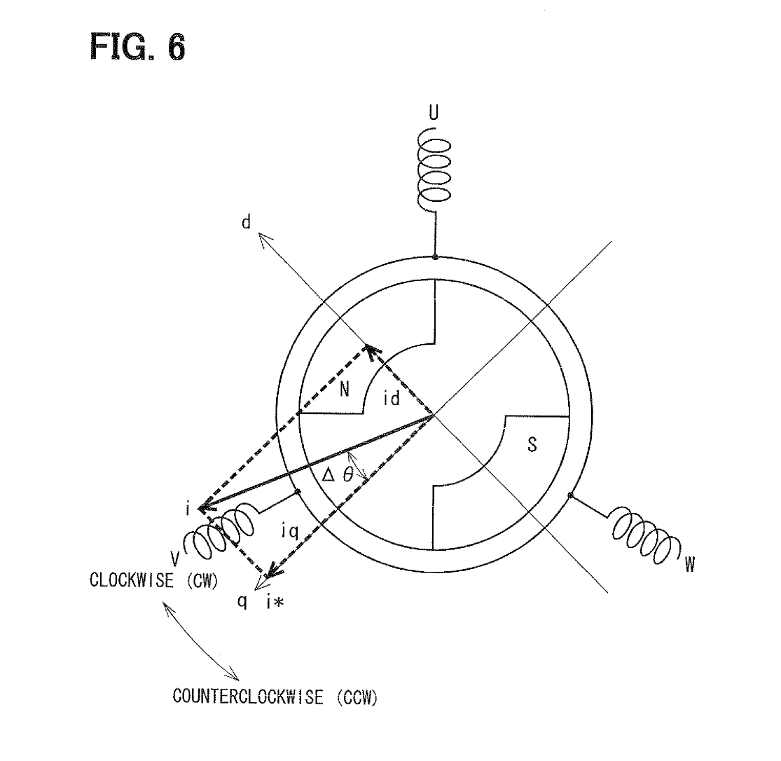

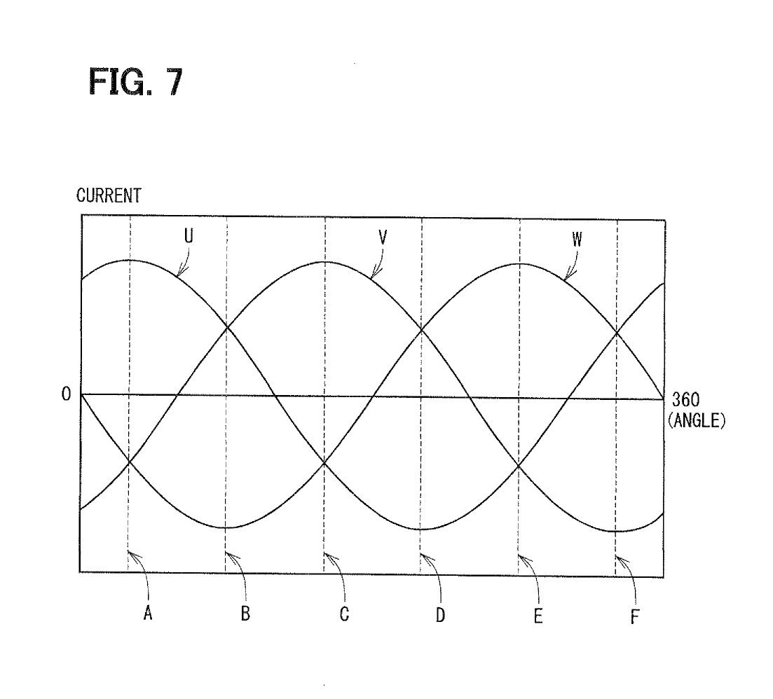

Subsequently, correction of the electric angle in the motor control will be described. FIG. 5 is a flow chart showing an electric angle correction processing. The present processing is executed in, for example, motor control after the device is assembled to a vehicle.

At step S300, the correction value stored in the correction value storage unit 17 is read. The correction value storage unit 17 stores the correction value on the side of clockwise and the correction value on the side of counterclockwise. In this case, the correction values on both sides are read.

At S310, it is determined whether the motor is in clockwise (CW) rotation. When it is determined that the motor is in clockwise rotation (S310: YES), the electric angle is corrected by utilizing the correction value on the side of clockwise at step S320. Thereafter, the electric angle correction processing is terminated. When it is determined that the motor is not in clockwise rotation (S310: NO), that is, when the motor is in counterclockwise rotation, the electric angle is corrected by utilizing the correction value on the side of counterclockwise at step S330. Thereafter, the electric angle correction processing is terminated.

Subsequently, determination of the rotative direction of the motor 30 executed at step S310 will be described.

(1) Utilize Motor Angular Speed

A motor angular speed is not influenced by the assembly offset angle. Therefore, the rotative direction can be determined by utilizing, for example, the motor angular speed obtained from a signal of the rotation angle sensor 40. In this case, the rotative direction may be simply determined according to a sign (negative and positive sign) of the motor angular speed. Alternatively, the rotative direction may be determined by comparison with a threshold having a predetermined hysteresis, not to cause hunching when the motor slightly rotates.

(2) Utilize Motor Angular Speed

An angular deviation may be utilized instead of the motor angular speed. In this case, a threshold having a hysteresis may be used similarly to the case where the angular speed is utilized.

(3) Utilize Induced Voltage Caused In Motor Rotation

An induced voltage caused at the time of motor rotation may be utilized instead of the motor angular speed and the angle deviation. When the motor rotates, induced voltage certainly occurs. In this case, a threshold having a hysteresis may be used similarly to the case where the motor angular speed is utilized and where the angular deviation is utilized.

(4) Utilize Combination

At least two of the above-described methods (1) to (3) may be combined and utilized.

As described above in detail, the motor control device 10 calculates the assembly offset angle at step S110 in FIG. 2. Specifically, electric current on the γ axis is set to 0 thereby to form a steady rotation state with no road. In the present condition, the error angle Δθ, which is the assembly offset angle θof, is calculated as the correction value from the voltage equation on the γ-δ axes. In this way, multiple patterns of lock electric currents need not be repeatedly supplied in order to enhance accuracy. Therefore, the assembly offset angle θof of the rotation angle sensor 40 is quickly detectable compared with a configuration in which lock electric currents are supplied.

Furthermore, the motor 30 is an SPM according to the present embodiment.

Therefore, as expressed by the equation (12), the d-axis inductance Ld and the q-axis inductance Lq are deemed to be equal to each other. Thereby, the voltage equation is simplified. In addition, the γ-axis electric current iγ is set to 0 in order to form the steady rotation state with no load. Thereby, the voltage equation is further simplified. Thus, as expressed by the equation (24), the error angle Δθ is calculated from the γ-axis voltage command value Vγ and the δ-axis voltage command value Vδ. In this way, a time period needed for calculation of the correction value is further shortened, and configuration of the device is simplified.

Furthermore, according to the present embodiment, both the clockwise side correction value and the counterclockwise side correction value are calculated in the calculation of the assembly offset angle at steps S210, S220 in FIG. 3. Thereafter, the rotative direction of the motor 30 is determined through the electric angle correction processing at step S310 in FIG. 5, and the electric angle is corrected by utilizing the correction value at steps S320, S330 according to the rotative direction. In this way, the electric angle is appropriately corrected irrespective of the rotative direction of the motor 30.

Furthermore, according to the present embodiment, the calculated correction value is stored in the correction value storage unit 17 at step S130 in FIG. 2 through the correction value calculation processing. In addition, the correction value is read from the correction value storage unit 17 at step S310 in FIG. 5 and the electric angle is corrected through the electric angle correction processing. In this way, the correction value need not be calculated at each time through the control.

Furthermore, according to the present embodiment, the error handling processing is executed at step S140 on determination that the correction value is abnormal (S120 in FIG. 2: YES) in the correction value calculation processing. In this case, the correction value is not stored in the correction value storage unit 17. In this way, control according to an inappropriate correction value is avoidable. Furthermore, according to the present embodiment, the correction value is set to 0 in advance of calculation of the assembly offset angle. In this way, the correction value can be appropriately calculated.

The correction value calculation processing executed by the motor control device 10 may be equivalent to a processing function of a correction value calculation unit. The electric angle correction processing executed by the motor control device 10 may be equivalent to a processing function of an electric angle correction unit.

In the above embodiment, the voltage equation on the γ-δ axes is simplified, and the error angle Δθ is calculated from the simplified voltage equation. Alternatively, the error angle Δθ may be calculated from the voltage equation expressed by the equation (8) as it is.

In the above embodiment, the correction value is calculated with respect to each of the rotative directions of the motor 30. Alternatively, the correction value may be calculated with respect to one of the rotative directions of the motor 30, such as the clockwise rotation, and the electric angle may be corrected by utilizing the calculated correction value, irrespective of the rotative direction of the motor 30.

In the above embodiment, the motor 30, which is an SPM, is the controlled object. Alternatively, another motor such as an internal permanent magnet motor (IPM) may be a controlled object.

Summarizing the embodiment, the motor control device detects biaxial electric currents on two axes, which intersect perpendicularly to each other, and performs feedback control according to deviations between the detected electric currents and target current values. The motor control device further calculates biaxial voltage command values on the two axes thereby to control a brushless motor.

The brushless motor may be, for example, a three-phase motor having U phase, V phase, and W phase. In order to simplify the control of the brushless motor, the electric currents detected on the three phases are converted into biaxial electric currents, which intersect perpendicularly to each other, by using an electric angle. Thus, the motor control device performs feedback control according to deviations between converted electric currents and target current values. The motor control device further calculates biaxial voltage command values. The motor control device converts the biaxial voltage command values into three-phase voltage command values by utilizing the electric angle and controls the brushless motor.

In this case, when an assembly error arises in the position of a rotation angle sensor mounted to the brushless motor, the γ axis and the δ axis, which are shifted from ideal control axes, become control axes. The γ axis represents a phase component, and the δ axis represents a torque component.

According to the present embodiment, the correction value calculation unit sets electric current on the γ axis to 0, thereby to form a steady rotation state with no road. In the present condition, the correction value calculation unit calculates the assembly error as the correction value from the voltage equation on the γ-δ axis. In this way, multiple patterns of lock electric currents need not be repeatedly supplied in order to enhance accuracy. Therefore, an assembly error of the rotation angle sensor is quickly detectable compared with a configuration in which lock electric currents are supplied.

The voltage equation may be calculated as it is. Alternatively, the voltage equation may be simplified to enable easier calculation of the correction value thereby to avoid complicated configuration of the device.

Specifically, on assumption that a d axis representing a phase component and a q axis representing a torque component are ideal biaxial control axes, an inductance on the d axis may be deemed to be equal to an inductance on the q axis.

Thereby, the voltage equation may be simplified, and the correction value may be calculated using the simplified voltage equation. In consideration that the motor used for an electric power steering system (EPS) is a surface permanent magnet motor (SPM), which has magnetic poles on the rotor surface, it is effective to simplify the voltage equation in such a method.

Furthermore, the voltage equation may be simplified on assumption that an electric current on the γ axis is set to 0 to be in a no-load steady rotation state, and the correction value may be calculated using the simplified voltage equation. Specifically, for example, the error angle may be calculated from voltage command values Vγ, Vδ on the γ axis and the δ axis from the subsequent equation (5).

$$Δ θ \approx {tan}^{- 1} ( - \frac{V γ}{V δ} ) \qquad ( 5 )$$

On the premise that the correction value is calculated before the device is assembled to a vehicle, the electric angle obtained from a signal of the rotation angle sensor may be corrected by using the calculated correction value in control of a brushless motor. In this way, variation in the electric angle caused by assembly error can be corrected in control of a brushless motor. Thus, appropriate control is enabled.

It is noted that an assembly error is theoretically constant even when the rotation direction of the brushless motor changes. However, calculated correction values may be different actually in dependence upon rotative directions. In consideration of this, the correction value calculation unit may separately calculate the correction values correspondingly to the rotative directions of the brushless motor. In this way, correction can be made with high accuracy according to the rotative direction of the brushless motor. Specifically, for example, The electric angle correction unit may determine the rotative direction of the brushless motor and may correct the electric angle using the correction value according to the determined rotative direction.

The correction value calculation unit may calculate the correction value before the device is assembled to a vehicle. The electric angle correction unit may correct the electric angle in control after the device is mounted to the vehicle. In consideration of this, a correction value storage unit may be further provided for storing the correction value calculated by the correction value calculation unit. In this case, the correction value calculation unit may store the correction value, which is set to 0, in the correction value storage unit in advance of calculation of the correction value. In this way, the correction value can be appropriately calculated.

In a condition where the calculated correction value is abnormal and when an electric angle is corrected using the abnormal correction value, control cannot be appropriately performed. In consideration of this, the correction value calculation unit may determine whether the calculated correction value is abnormal and may execute an abnormal-state processing when the calculated correction value is abnormal. The abnormal-state processing may be, for example, a processing to notify abnormality or a processing to cancel storing of the correction value.

For example, the correction value calculation unit may calculate the correction value on an instruction from an external object through a communication or a direct instruction. The direct instruction may be made via a switch device such as a DIP switch provided to the device.

The above processings such as calculations and determinations are not limited being executed by the motor control device 10. The control unit may have various structures including the motor control device 10 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A motor control device configured to detect electric currents on two perpendicular axes and calculate voltage command values on the two perpendicular axes according to deviations between the detected electric currents and target current values respectively thereby to perform feedback control of a brushless motor equipped with a rotation angle sensor, the motor control device comprising:
a correction value calculation unit configured to, on the premise that ideal control axes are shifted to γ-δ control axes, which include a γ axis representing a phase component and a δ axis representing a torque component, due to an assembly error of the rotation angle sensor, set an electric current on the γ axis to 0 to establish a no-load steady rotation state and calculate the assembly error as a correction value from a voltage equation on the γ-δ control axes.

2. The motor control device according to claim 1, wherein the correction value calculation unit is further configured to, on the premise that the ideal control axes include a d axis representing a phase component and a q axis representing a torque component, calculate the correction value using a voltage equation, which is simplified on assumption that an inductance on the d axis is equal to an inductance on the q axis.

3. The motor control device according to claim 2, wherein the correction value calculation unit is further configured to calculate the correction value using a voltage equation, which is simplified on assumption that the electric current on the γ axis is set to 0 to be in the no-load steady rotation state.

4. The motor control device according to claim 3, wherein the correction value calculation unit is further configured to calculate the correction value by substituting a voltage command value on the γ axis and a voltage command value on the δ axis into the following equation c1.
$$Δ θ \approx {tan}^{- 1} ( - \frac{V γ}{V δ} ) \qquad c 1$$

5. The motor control device according to claim 1, further comprising:
an electric angle correction unit configured to correct an electric angle, which is obtained from a signal of the rotation angle sensor, by using the correction value calculated by the correction value calculation unit in control of the brushless motor.

6. The motor control device according to claim 5, wherein the correction value calculation unit is further configured to calculate the correction value correspondingly to each of rotative directions of the brushless motor.

7. The motor control device according to claim 6, wherein the electric angle correction unit is further configured to determine rotative direction of the brushless motor and correct the electric angle using the correction value according to the determined rotative direction.

8. The motor control device according to claim 1, further comprising:
a correction value storage unit configured to store the correction value calculated by the correction value calculation unit.

9. The motor control device according to claim 8, wherein the correction value calculation unit is further configured to set the correction value to 0 and store the correction value in the correction value storage unit in advance of calculation of the correction value.

10. The motor control device according to claim 1, wherein the correction value calculation unit is further configured to determine whether the calculated correction value is abnormal and execute an abnormal-state processing when the calculated correction value is abnormal.

11. The motor control device according to claim 1, wherein the correction value calculation unit is further configured to calculate the correction value in response to at least one of an instruction from an external object through a communication and a direct instruction.

12. A method for controlling a brushless motor equipped with a rotation angle sensor, the method comprising:
on the premise that ideal control axes of the brushless motor are shifted to γ-δ control axes, which include a γ axis representing a phase component and a δ axis representing a torque component being perpendicular to each other, due to an assembly error of the rotation angle sensor, setting an electric current on the γ axis to 0 to establish a no-load steady rotation state and calculating the assembly error as a correction value from a voltage equation on the γ-δ control axes;
obtaining an electric angle from a signal of the rotation angle sensor;
correcting the obtained electric angle by using the calculated correction value in feedback control of the brushless motor;
detecting electric currents on the control axes with reference to the corrected electric angle; and
calculating voltage command values on the control axes according to deviations between the detected electric currents and target current values respectively thereby to perform the feedback control of the brushless motor with reference to the corrected electric angle.

13. A computer readable medium comprising instructions executed by a computer, the instructions including the method according to claim 12.
